(19) United States
(12) Patent Application Publication
(10) Pub. No.: US 2003/0088485 A1
(43) Pub. Date: May 8, 2003

(54) Multi-dimensional advertising

(76) Inventor: Paul Feinberg, River Vale, NJ (US)

Correspondence Address: MILLER PATENT SERVICES, 2500 DOCKERY LANE, RALEIGH, NC, 27606, US

(21) Appl. No.: 10/107,789

(22) Filed: Mar. 27, 2002

Related U.S. Application Data
(60) Provisional application No. 60/337,963, filed on Nov. 8, 2001.

(51) Int. Cl. G06F 17/60

(52) U.S. Cl. 705/27

(57) ABSTRACT

A multi-layer advertising arrangement. A user, by operating a prescribed switch on a radio receiver or the like, can mark content that is being received. The receiver then establishes an Internet connection and sends an index or bookmark stored as a result the user marking the content to an advertising broker. The advertising broker determines from the index or bookmark what programming corresponds to the content and determines what advertisers have purchased advertising rights associated with the time that the content was aired. The advertising broker then sends information to the computer that is used to display a menu. The menu provides links to multiple retailers that have purchased opportunities to have broadcast listeners sent links to their online retail sites.

### CROSS REFERENCE TO RELATED DOCUMENTS

This application is related to and claims priority benefit of U.S. Provisional Application Serial No. 60/337,963, filed Nov. 8, 2001 which is hereby incorporated herein by reference.

### FIELD OF THE INVENTION

This invention relates generally to the field of advertising. More particularly, this invention relates to creation of multi-dimensional advertising for a given advertising time.

### BACKGROUND OF THE INVENTION

Many services have been devised for the Internet that fulfill the needs of the consumer but fail to produce enough revenue to make them cost effective to the provider. As a result, there have been many companies with good ideas that have been unable to survive. Many of these companies attempted to produce revenue by the sale of advertising space. Many of the attempts to sell advertisement through banners and spawned windows have unfortunately proven ineffective at producing adequate revenue. This is the case even though there are ways to pipe these advertisements directly to the desired demographics, which should lead to enhanced sales for a given product.

### SUMMARY OF THE INVENTION

The present invention relates generally to advertising. Objects, advantages and features of the invention will become apparent to those skilled in the art upon consideration of the following detailed description of the invention.

In certain embodiments consistent with the present invention, a multi-layer advertising arrangement is provided in which a user, by operating a prescribed switch on a radio receiver or the like, can mark content that is being received. The receiver then establishes an Internet connection and sends an index or bookmark (stored as a result the user marking the content) to an advertising broker. The advertising broker determines from the index or bookmark what programming corresponds to the content and determines what advertisers have purchased advertising rights associated with the time that the content was aired. The advertising broker then sends information to the computer that is used to display a menu. The menu provides links to multiple retailers that have purchased opportunities to have broadcast listeners sent links to their online retail sites.

A method of providing multiple levels of advertising, consistent with certain embodiments of the present invention, includes receiving the identifier from a user as an indication that the user has interest in information relating to the content; associating an identifier with a segment of content broadcast by a content broadcaster and with at least one advertiser; and sending the user a link to the at least one advertiser.

An advertising system, consistent with certain embodiments of the present invention has a receiver that receives content from a broadcaster, the receiver being responsive to a user input, for storing an indicator indicating that the user has interest in the content. The system associates the indicator with an advertiser that has purchased rights to an advertising time slot associated with the content, and links to an Internet address associated with the advertiser.

An advertising method, consistent with certain embodiments of the present invention, includes connecting a receiver to an audio system; storing codes associated with content received by the audio system; establishing an Internet connection to an advertising broker; transmitting the codes to the advertising broker; receiving information regarding one or more advertisers from the advertising broker in response to receipt of the codes; generating a menu associated with the one or more advertisers; and responsive to a menu selection, linking to an advertiser.

Another advertising method, consistent with certain embodiments of the invention, includes associating broadcast content with broadcast times for a content broadcaster; selling advertising for the broadcast times to one or more advertisers; receiving codes from a user indicative of interest by the user in the content broadcast by the content broadcaster; and responsive to receiving the codes, transmitting information identifying the one or more advertisers to the user.

Another advertising method, consistent with certain embodiments of the present invention, includes selling advertising rights associated with specified broadcast content to a plurality of advertisers; receiving information from a user computer expressing interest in the specified broadcast content; associating the broadcast content with the plurality of advertisers; sending a plurality of Internet links to web sites of the plurality of advertisers to the user; presenting the user with a menu representing the plurality of links to a plurality of web sites; and upon selection from the menu, linking the user computer to a web site associated with the selection from the menu.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a diagram of an advertising system for digital radio consistent with certain embodiments of the present invention.

FIG. 2 is a flow chart illustrating a multi-dimensional advertising scenario example consistent with certain embodiments of the present invention.

FIG. 3 is a diagram illustrating the communication for an exemplary multi-dimensional advertising example consistent with certain embodiments of the present invention.

FIG. 4 is a diagram illustrating the communication for another exemplary multi-dimensional advertising example consistent with certain embodiments of the present invention.

FIG. 5 is a diagram illustrating the interaction of the various entities in an exemplary multi-dimensional advertising scenario consistent with certain embodiments of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

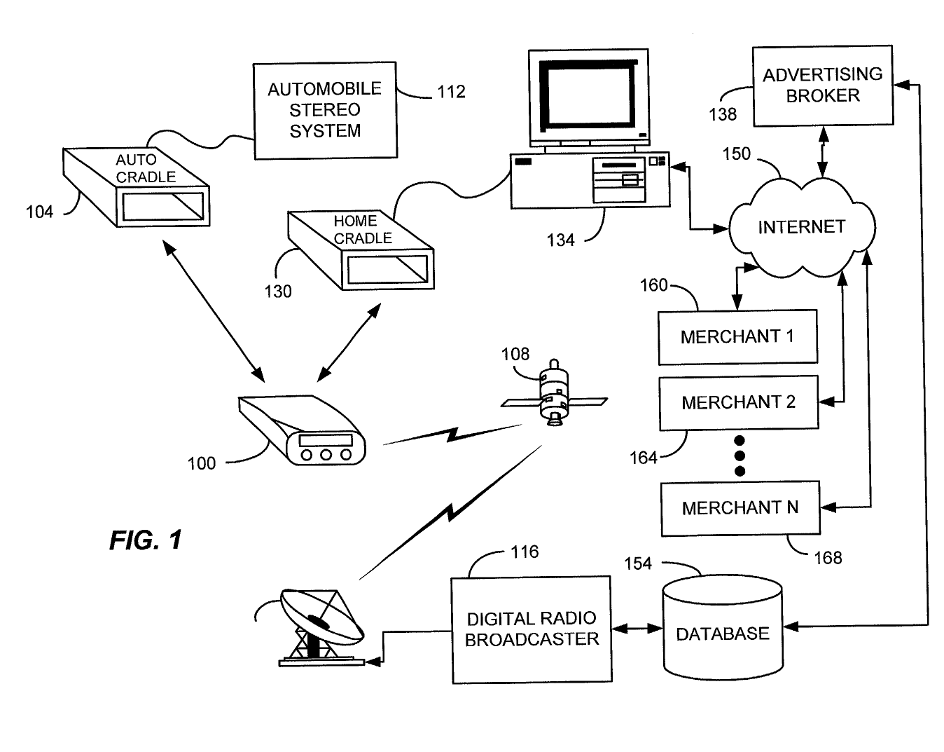

Turning now to FIG. 1, an exemplary diagram of an advertising system for digital radio consistent with certain embodiments of the present invention is illustrated. In this example, a receiver 100 is provided that, for a given broadcasting system (DTV, DAB, Cable TV, etc.), allows the user (listener, viewer, etc.) to “mark” content of interest. For example, in the case of a radio receiver such as a digital radio receiver, the user can push a button on the digital radio receiver 100 front panel or remote control, which stores an index, identifier or marker associated with a song that is playing. This marker can then be used to access detailed information related to that song at some later time.

In the example system of FIG. 1, a digital satellite radio system is illustrated in which digital radio receiver 100 is installed within a cradle 104 within a user's automobile. The user can then receive digital radio broadcasts, such as those provided by XM™ satellite radio using transmissions from a satellite 108, which are played through the automobile's stereo audio system 112. Such digital receivers are commercially available as, for example, Sony Corporation's DRN-XM01C digital Audio Receivers. Such receivers have a built in function that permits storing an identifier associated with a currently playing music selection as a “memo” function.

The digital radio broadcasts originate with a digital radio broadcaster 116 that beams programming of digital content using a satellite antenna 122 to the satellite 108. Such broadcasts include identifying information associated with each musical selection, and can also readily provide similar identifying information for any given segment of broadcast content, be it news, commentary, music, or advertisements.

In accordance with certain embodiments consistent with the present invention, the user can also connect the receiver 100 to another cradle device 130 that can be connected, e.g. using a Universal Serial Bus (USB) connection, IEEE 1394 connection or other serial or parallel computer connection, to a personal computer 134 or other computer device. Using software residing on the computer 134, the user is able to retrieve the identifying information for content of interest that has been marked using the memo function of receiver 100. In accordance with certain embodiments, this can provide a basis for multi-dimensional advertising directed at the user, and which should be of interest to the user.

In one embodiment, the user is able to retrieve the identifying information from receiver 100 through cradle 130 to computer 134. Since this identifying information may simply be an alphanumeric code representing a time associated with a particular broadcast, or otherwise unintelligible encoded data, computer 134 can then contact a service provider acting in the capacity of (or equivalently, in cooperation with) an advertising broker 138 via the Internet 150. The advertising broker 138, using access to a database 154 (either through dedicated communication channels or through the Internet or other communication mechanism) ascertain greater detail of information regarding the broadcast content marked by the user.

The advertising broker 138, upon receipt of more detailed information from the database 154, can determine, using its own records, which advertisers are associated with the advertising space that is associated with the content selected by the user. Accordingly, advertising broker 138 sends a menu (or equivalently, sends information used at the computer 134 to build a menu) to the computer 134 of selections that can be made by the user. The user can the make any of a plurality of selections that can lead to one or more merchants 160, 164, . . . , 168 that have purchased rights to advertise in a manner associated with the content selected by the user. The menu may take the form of icons associated with links to a merchant's web site.

Thus, the advertising broker 138, of the current embodiment, serves to market advertising rights associated with content or broadcast times of content (whether the content is music, sponsorship type advertising or other types of broadcast content) to one or more merchants. The merchants are then able to have customers directed by Internet links to their online stores to obtain products or services. In this example, the advertising broker 138 further serves the function of obtaining information from the content broadcaster's database to associate codes transmitted from the user with content or advertisements and then further associate the output of the database with the advertisers who have purchased advertising rights. The advertising broker 138 then assembles a menu for display to the user in order to facilitate the user's selection of a link to one of the advertisers. In other embodiments, multiple service providers can equivalently work in association to accomplish the same result. Moreover, while the present embodiment relies on the content provider to translate the codes sent from the user's receiver 100 into identification of content or broadcast times, in other embodiments, this information can be tracked by a separate service without departing from the invention.

Thus, once the user is able to retrieve the information associated with these the content that was marked (over the Internet, for example), a catalog of products associated with the marked item (song, commercial, TV program, etc.) is offered to the consumer. In one example, the content might be a song that the user enjoys. Examples of products associated with the song could be the song itself, the associated CD, T-Shirt, concert tickets, etc.

It should be noted that in systems and processes consistent with embodiments of the present invention, the advertisement mechanism can be independent of the content broadcaster 116. Moreover, the advertisement mechanism can be independent of the traditional advertisers that pay fees to the content broadcaster 116 to sponsor presentation of the broadcast content. Multiple layers of advertising can thus be provided, using embodiments of the present invention, by selling rights to provide advertisement during time slots associated with broadcast content that can be marked and stored by the user.

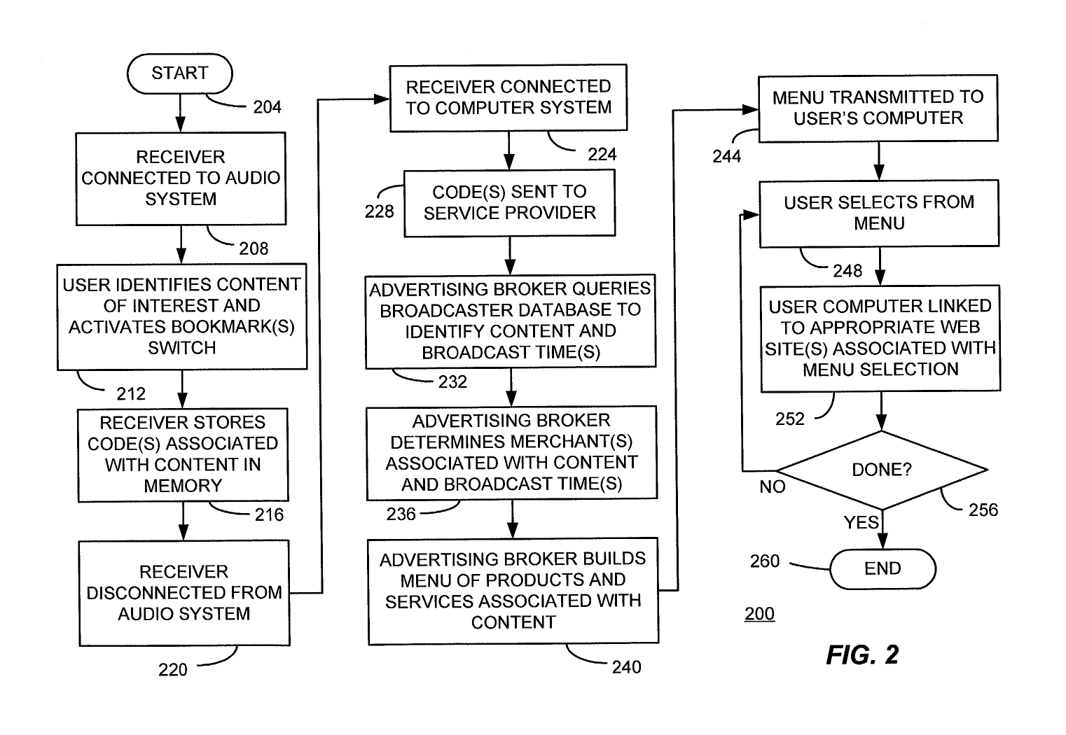

Referring now to FIG. 2, an exemplary scenario is illustrated in the form of flow chart 200 in which a user is provided with the information and advertising of the present invention. The process starts at 204 after which the receiver 100 is installed in automobile cradle 104 or otherwise connected to an audio system at 208. The user then identifies content that is of interest at 212 by activating a “memo” switch or “bookmark” switch in order to “bookmark” the content of interest. The receiver 100 stores a code or other information associated with the content in memory at 216 for later retrieval.

When a listening session is completed and the user wishes to retrieve the identifiers (bookmarks), the receiver is disconnected from the audio system 112 (in this embodiment) and connected to the computer 134 using cradle 130 at 224 (also in this embodiment. In other embodiments, other interconnection schemes can be used without departing from the present invention.) The stored bookmark codes (identifiers) are then sent to the advertising broker 138 at 228 and the advertising broker queries the broadcaster's database to identify the content. Such identification may include, but is not limited to, a broadcast time and other identifying information.

The advertising broker 138 then identifies advertisers (e.g., merchants and other service providers), that have purchased advertising space associated with this broadcast time slot at 236. The advertising broker 138 then builds a menu at 240 (or equivalently assembles information that the computer 134 can use to build a menu) and sends the menu to the computer 134 at 244 for display to the user. The user can then select from the menu at 248 and the user's computer is linked to an appropriate web site at 252 associated with the menu selection. This web site may in turn provide links to the advertiser's home page or other associated web sites. If the user is not done at 256, other menu selections can be made at 248. When the user is done at 256, the process ends at 260.

Given this scenario, a new business model arises if the time during which the content is broadcast is sold as advertising space to potential merchants or service providers (advertisers) in a manner separate and distinct from traditional sponsorship of the content. For example, in one embodiment, if the content in this case is a song, show or commercial the merchant can bid (i.e., compete) for the opportunity to advertise during play of particular songs. However, since a catalog of products is offered for the given piece of content, several retailers can buy time for the same time slot. It therefore allows for a multi-dimensional advertising space. This airtime could be sold at a premium during the prime time hour of 8 pm for example or at a very low rate if it airs in the middle of the night.

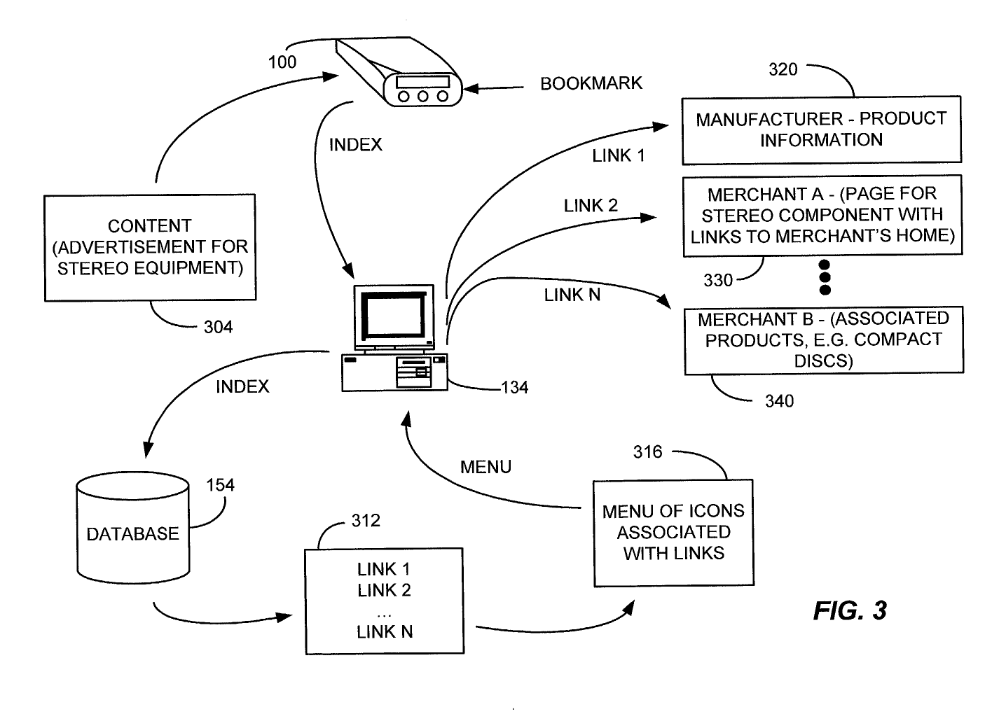

By way of example, and not limitation, consider the scenario illustrated in FIG. 3. In this example, the content 304 could be a radio commercial (i.e., a traditional advertisement sponsoring presentation of the content) for a manufacturer's stereo equipment (e.g., a particular brand of CD Player). This commercial content is aired on the digital satellite radio and payed for by the manufacturer in a conventional manner. If the user is interested in further information, a bookmark can be made using the digital radio receiver 100. This produces an index that is then read by computer 134 as previously described.

A merchant that sells the particular CD player (Merchant A) might purchase exclusive rights to the opportunity to sell that particular CD Player if the listener marks the commercial. Another retailer (merchant B) could also buy that slot for other products or content. An example might be a CD retailer which sells CDs over the Internet. The objective would be to sell rights to advertise in the same space to multiple and non-competing merchants. These advertising spaces created in accordance with the present invention constitute a new layer of advertising associated with the content.

Thus, in accordance with this scenario, when the index is received by the computer 134, it is sent to the advertising broker 138 who uses the index as an entry point into database 154 to determine information about the content. From this information, the advertising broker 138 generates a list of links 312 that are used to create a menu of icons associated with the links and sends the menu back to the user's computer 134. Using the menu, the user can then access the manufacturer for product information 320, can access Merchant A at 330 to directly purchase the CD player or can access merchant B at 340 if there is interest in purchasing CDs. Other products and services can also be offered associated with the same content creating the multi-dimensional advertising space of the current invention.

In the above example, the multi-dimensional advertising space is created on top of a traditional sponsorship advertisement. In other examples the content might be music and the multi-dimensional advertising space is associated with the music content but creates new advertising space on top of the sponsorship advertising associated with the content. When the music is marked, the advertising space can be used, for example, to sell the actual CD along with a CD Player, the artist's other CDs, T-Shirts, Concert tickets, etc. Moreover, this invention could be implemented on any broadcasting platform including, but not limited to, the Internet (multi-casting), Radio, TV, satellite TV, etc.

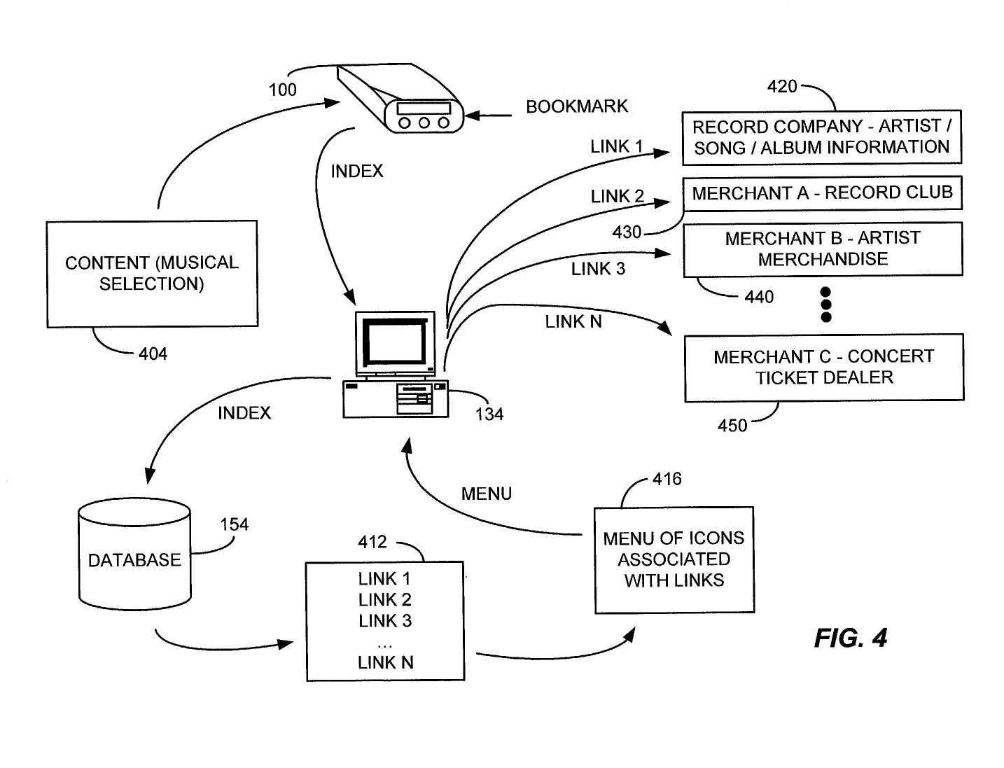

By way of a second example, and not limitation, consider the scenario illustrated in FIG. 4. In this example, the content 404 could be a musical selection played over the digital radio. This content is aired on the digital satellite radio in a conventional manner. If the user likes the musical selection, a bookmark can be made using the digital radio receiver 100. This produces an index that is then read by computer 134 as previously described.

A record label that produces the particular selection might purchase exclusive or non-exclusive rights to the opportunity to advertise if the listener marks the musical selection. A record club (merchant A) might also wish to advertise if that selection is selected. Another retailer (merchant B) could also buy that slot for other products or content. An example might be a retailer of artist merchandise (T-shirts, hats, etc.) Other retailers such as CD retailers which sells CDs over the Internet might also be interested in purchasing advertising. In this example, a ticket broker (merchant C) might also wish to advertise.

Thus, in accordance with this scenario, when the index is received by the computer 134, it is sent to the advertising broker 138 who uses the index as an entry point into database 154 to determine information about the content. From this information, the advertising broker 138 generates a list of links 412 that are used to create a menu of icons associated with the links and sends the menu back to the user's computer 134. Using the menu, the user can then access the record company for more information about the artist and his albums at 420, can access Merchant A at 430 to join a record club, can access merchant B at 440 to purchase related merchandise or can access merchant C at 450 if there is interest in purchasing concert tickets. Other products and services can also be offered associated with the same content creating the multi-dimensional advertising space of the current invention.

In one exemplary embodiment consistent with the present invention a simple index (or bookmark) is transmitted with each piece of broadcast content. The index (or bookmark) is mapped to a look-up table accessible over the Internet or through a back channel over the broadcast system. An example of such a back channel might be using a cellular system in conjunction with the broadcast system to communicate in the opposite direction.

An exemplary format for a bookmark is as follows:

Platform ID: Channel:Start Time:Product Type:Product I

In another embodiment, the bookmark can also be formatted to exclude fields that are already provided by the system. For example, a broadcaster and an associated receiver may offer some of the fields (e.g., platform ID, channel, etc.) that are included in the bookmark format recited above. In such cases, the bookmark format would not have such fields.

In other embodiments, the bookmark format is flexibly structured to include all possible fields as options selected through field presence indicators or format types. In one exemplary embodiment, for example, the bookmark includes features that will allow the bookmark to have a variable length. In another exemplary embodiment, the bookmark is formatted based on the broadcast platform application.

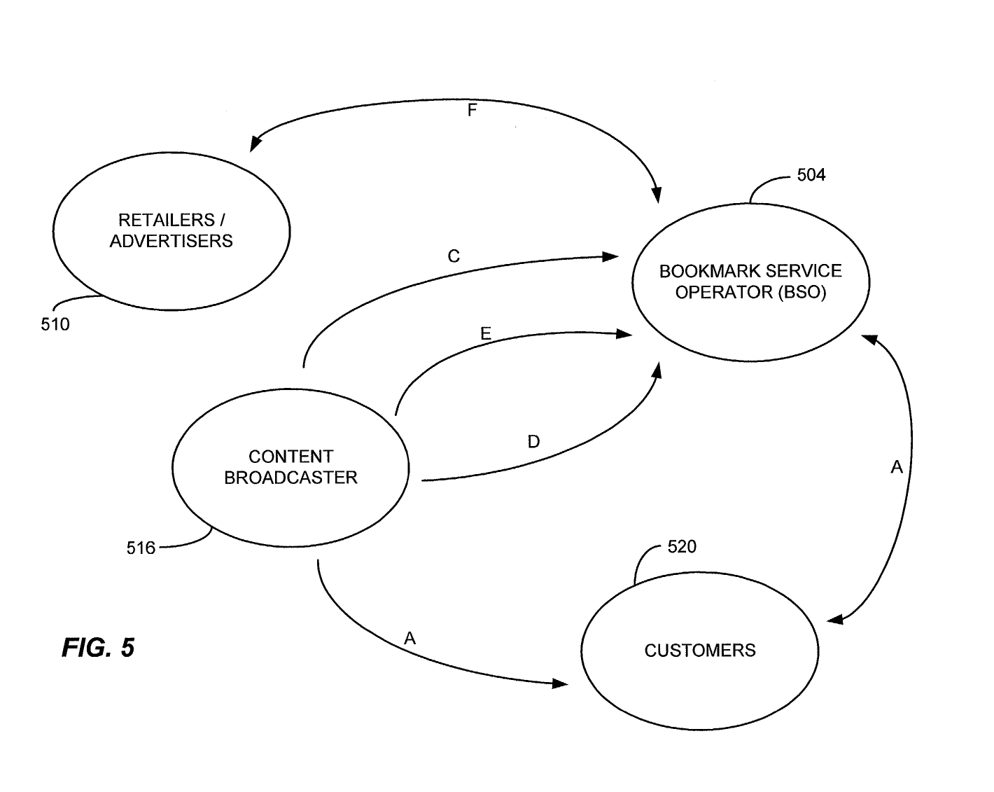

An embodiment describing the communication required between the Bookmark Service Operator (BSO), Broadcaster and the Retailer is illustrated in FIG. 5 and set forth in the description below.

The BSO 504 acts as the advertising broker (138) for advertising space that is made available using the bookmark described above. The BSO sells a bookmark opportunity to different retailers or other merchants (advertisers) 510 that are interested in selling their products and/or services during a specific broadcast time slot. For instance, if a Broadcaster 126 airs a commercial that is sponsored by a manufacturer of a game console, a retailer who sells the game console other retailers who sell game software may want to buy the bookmark associated with the air time during which the game manufacturer's commercial is broadcast.

Since the customer or user 520 is referred to a catalog when he or she goes online, a single bookmark can be sold to many retailers for the same broadcast time slot. This creates a multi-dimensional advertising space. In the foregoing example, if a commercial for the game console is broadcast, the user 520 would be referred to the retailer for the physical game console device, and to another retailer for game console software. In the case where a song is the content broadcast from 516 there may be different retailers 510 selling the song on a CD, concert tickets for the artist performing the broadcast song, apparel associated with the artist and so on.

The BSO 504 can derive revenue from retailers 510 who pay for the exclusive air time. In other embodiments, the BSO 504 can obtain royalty revenue from sales and coupons. In such an embodiment, coupons could be implemented through a Website interface and downloaded for printout/download. In alternative embodiments, coupons could also be transferred from a broadcast receiver to a handheld device, such as a PDA, via USB, memory stick, Bluetooth, and other communication media.

In the illustrated embodiment, the bookmark does not have to have a Product ID for the Broadcast platform. If the receiver gets the Start-time and Channel, the BSO 504 can refer to a look-up table to determine which Retailer(s) bought the airtime and what product (Product ID) it is selling. Therefore, the resulting bookmark format is reduced to just the Start-Time of the broadcast content (for example, a commercial or a song) since the channel information could come directly from the receiver.

When a retailer 510 buys the air time for the bookmark, it may not be known what is playing at a given time since, for example, in the case of broadcast music, a disk-jockey (DJ) can create his own play-list. In some cases, the Retailer 510 may not care what song is playing. Most Retailers stock every popular song or music of a particular genre, and may be willing to buy air time based on time. For instance, broadcast air time during prime-time sells at a premium price. If a Retailer 510 wants to buy a bookmark for a particularly popular song, it can simply claim the bookmark the next time the song is aired by the Broadcaster 516 or negotiate with the BSO 504 to influence Broadcaster's play-list and play it at a particular time.

For commercials, there is a Commercial ID, and the scheduling of commercials is generally fixed in advance. Therefore, the Broadcaster 516 could send a table of Commercial IDs and descriptions in advance to the BSO 504 on at most a daily basis.

The present invention can be implemented on any broadcasting platform, including the Internet (multicasting), radio, analog or digital TV via cable, terrestrial broadcast, or satellite, and other platforms. Also, the user can mark any type of broadcast content including but not limited to music, commercials, movies, songs, DJs, Newscasts, Interviews, and so forth.

In one embodiment of the invention, the content is marked for commercial opportunity. In other embodiments of the invention, the marks are stored so that the user can operate in a special broadcast receiver mode. This mode would be similar to a radio's search mode but instead of search among channels, it would search the content for whatever is marked.

For instance, if the user marked a song and initiated a search using that mark, then as the receiver searched through its channels, it would only stop if it found that artist or that particular song. It could even search for that category of music. The method of implementing this feature might be to offer a list of parameters associated with the content that was marked. The user would select from these parameters before beginning the search. For instance, if the user marked music, then the user would choose from category of music, artist, or song before beginning the search among radio channels. If an index is stored with the received content, then the Receiver 100 need only search all the received content over any given channel for this particular index.

The communications illustrated in FIG. 5 are summarized below for an exemplary embodiment:

A=Bookmark contains just Start Time. Radio receives either Commercial ID or Song/Title/Artist in Broadcaster's Broadcast data stream. Receiver knows what channel it is tuned to.

B=Client application (which is implemented with correct URL) communicates to BSO to get catalog of options associated with A (start time and channel); Each option has a different product offering (e.g., CD, Song, Tickets, T-shirt, etc.) and thumbnails (URL) for each.

C=Broadcaster provides entire listing of songs from music library. This can be carried out on the basis of a periodic or occasional update.

D=Broadcaster provides Electronic Program Guide of scheduled commercials and scheduled songs. This can be carried out on the basis of a periodic or occasional update.

E=Periodic updates to listing of songs from music library since it will grow.

F=Retailer makes requests to purchase commercial slot for Bookmark. This can be carried out on the basis of a periodic or occasional update.

One mode of operation of the invention, as illustrated above, is to send a simple index with each piece of content. The index can be mapped to a table look-up accessible over the Internet or through a back channel over the broadcast system. An example of such a back channel might be using a cellular system in conjunction with the broadcast system to communicate in the opposite direction.

This invention can be applied to any content that is sent over a given media. If it is a broadcasting media (Internet, Radio Broadcasting, TV Broadcasting, etc.) then the user can mark any content including music, commercials, movies, songs, DJs, Newscasts, Interviews, etc. In the description of the invention, the content is marked for commercial opportunity. However, these marks could also be stored so that the user could operate in a special broadcast receiver mode. This mode is similar to a radio's search mode but instead of search among channels, it would search the content for whatever is marked.

For instance, if the user marked a song and initiated a search using that mark, then as the receiver searched through its channels, it would only stop if it found that artist or that particular song. It could even search for that category of music.

The method of implementing this feature might be to offer a list of parameters associated with the content that was marked. The user would select from these parameters before beginning the search. For instance, if the user marked music, then the user would choose from category of music, artist, or song before beginning the search among radio channels.

If an index is stored with the received content, then the receiver need only search all the received content over any given channel for this particular index.

The above exemplary embodiments are described in terms of an automobile based digital satellite radio system. However, those skilled in the art will appreciate that many variations are possible without departing from the invention. By way of example, the above embodiments utilize a pair of docking stations that connect either to the automobile stereo system or a computer in order to alternately either play digital radio content on the stereo system or carry out operations over the Internet. However, other arrangements are possible. In order to access the advertising broker in the embodiment illustrated, the computer is used to establish an Internet link to the advertising broker. However, it is contemplated that other mechanisms can be used including, but not limited to, coupling to the Internet through a cellular telephone system or directly connecting the digital radio to a telephone line or to a network connection such as a local area network Ethernet connection or the like. The present embodiments merely contemplate that an Internet connection be established to contact the advertising broker, without limits on the actual mechanism used to establish the connection. Moreover, although an automobile stereo system is depicted as hosting the digital radio receiver 100 to provide the audio, it is noted that computer systems or portable, console or component stereo systems could provide the audio, either as a host for a receiver or having digital radio built in. Additionally, although digital radio is depicted delivering the content of the current invention, any other suitable content delivery system could be readily adapted to use the present invention.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

The present invention, as described in embodiments herein, is implemented using a programmed processor executing programming instructions that are broadly described above in flow chart form that can be stored on any suitable electronic storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of providing multiple levels of advertising, comprising:
receiving the identifier from a user as an indication that the user has interest in information relating to the content;
associating an identifier with a segment of content broadcast by a content broadcaster and with at least one advertiser; and
sending the user a link to the at least one advertiser.

2. The method according to claim 1, wherein the at least one advertiser comprises a plurality of advertisers, and wherein the sending comprises sending a plurality of links to the plurality of advertisers.

3. The method according to claim 1, wherein the identifier is received from the user by the user actuating a control on a receiver during receipt of the content from the content broadcaster.

4. The method according to claim 1, wherein the associating comprises conducting a query of a database associating the identifier with a broadcast time, and associating the broadcast time with at least one advertiser.

5. The method according to claim 1, wherein the associating comprises conducting a query of a database associating the identifier with the broadcast content and associating the broadcast content with at least one advertiser.

6. The method according to claim 1, wherein the content is broadcast as a digital satellite radio broadcast.

7. The method according to claim 1, wherein sending the user a link to the at least one advertiser comprises sending a menu to the user.

8. An advertising system, comprising:
a receiver that receives content from a broadcaster, the receiver having means, responsive to a user input, for storing an indicator indicating that the user has interest in the content;
means for associating the indicator with an advertiser that has purchased rights to an advertising time slot associated with the content; and
means for linking to an Internet address associated with the advertiser.

9. The system according to claim 8, wherein the means for associating the indicator comprises:
means for establishing an Internet connection with an advertising broker; and
means for receiving a menu of advertisers from the advertising broker.

10. The system according to claim 8, wherein the means for linking comprises means responsive to a user's menu selection for establishing an Internet link to the Internet address associated with the advertiser.

11. The system according to claim 8, wherein the receiver comprises a digital satellite radio receiver.

12. The system according to claim 8, further comprising a first interface for connecting to receiver to an audio system for playing the content for the user, and a second interface for connecting the receiver to a computer system for associating the indicator with an advertiser and for linking to the Internet address of the advertiser.

13. The system according to claim 12, wherein the audio system comprises an automobile audio system.

14. The system according to claim 12, wherein the second interface comprises one of a serial computer interface, a Universal Serial Bus interface, an IEEE 1394 interface and a parallel computer interface.

15. The system according to claim 12, wherein at least one of the first and second interfaces is made by connection of the receiver to a cradle.

16. An advertising method, comprising:
connecting a receiver to an audio system;
storing codes associated with content received by the audio system;
establishing an Internet connection to an advertising broker;
transmitting the codes to the advertising broker;
receiving information regarding one or more advertisers from the advertising broker in response to receipt of the codes;
generating a menu associated with the one or more advertisers; and
responsive to a menu selection, linking to an advertiser.

17. The method according to claim 16, wherein the codes are stored in response to a user actuating a control on the receiver.

18. The method according to claim 16, wherein the receiver comprises a digital satellite radio receiver.

19. The method according to claim 16, wherein the menu comprises a menu of products or services provided by the one or more advertisers;

20. The method according to claim 16, wherein the menu is generated by the advertising broker and wherein the menu comprises the information regarding the one or more advertisers.

21. An advertising method, comprising:
associating broadcast content with broadcast times for a content broadcaster;
selling advertising for the broadcast times to one or more advertisers;
receiving codes from a user indicative of interest by the user in the content broadcast by the content broadcaster; and
responsive to receiving the codes, transmitting information identifying the one or more advertisers to the user.

22. The method according to claim 21, wherein the information identifying the one or more advertisers comprises a menu, and wherein selection from the menu links the user to an advertiser's web site.

23. The method according to claim 21, wherein the information identifying the one or more advertisers comprises one or more links to the one or more advertiser's web sites.

24. The method according to claim 21, wherein the receiving and transmitting are carried out via the Internet.

25. An advertising method, comprising:
selling advertising rights associated with specified broadcast content to a plurality of advertisers;
receiving information from a user computer expressing interest in the specified broadcast content;
associating the broadcast content with the plurality of advertisers;
sending a plurality of Internet links to web sites of the plurality of advertisers to the user;
presenting the user with a menu representing the plurality of links to a plurality of web sites; and
upon selection from the menu, linking the user computer to a web site associated with the selection from the menu.
